(19) United States
(12) Patent Application Publication
(10) Pub. No.: US 2019/0366451 A1
(43) Pub. Date: Dec. 5, 2019

(54) Drill Bit Having a Spiral-Tube-Shaped Drill Shaft and Method for Producing a Spiral-Tube-Shaped Drill Shaft for a Drill Bit

(71) Applicant: Hilti Aktiengesellschaft, Schaan (LI)

(72) Inventors: Florian SCHROEDER, Maienfeld (CH); Christoph WEBER, Oberaegeri (CH); Roland SCHNEIDER, Schlins (AT)

(73) Assignee: Hilti Aktiengesellschaft, Schaan (LI)

(21) Appl. No.: 16/472,695

(22) PCT Filed: Nov. 28, 2017
(86) PCT No.: PCT/EP2017/080663

§ 371 Date: Jun. 21, 2019

(30) Foreign Application Priority Data
Dec. 23, 2016 (EP) 16206533.8

(51) Int. Cl. B23B 51/04; E21B 10/62

(52) U.S. Cl. CPC B23B 51/042; E21B 10/62; E21B 17/046; B23B 2250/12; B23B 2251/408; B23B 2240/16

(57) ABSTRACT

A drill bit for creating a borehole includes a drill shaft portion which has a tubular drill shaft, a receiving portion which has a cover and an insertion end, and a connecting device which connects the drill shaft portion and the receiving portion together releasably or non-releasably. The tubular drill shaft is configured as a welded spiral tube.

### CROSS REFERENCE TO RELATED APPLICATIONS

This application claims the priority of International Application No. PCT/EP2017/080663, filed Nov. 28, 2017, and European Patent Document No. 16206533.8, filed Dec. 23, 2016, the disclosures of which are expressly incorporated by reference herein.

### BACKGROUND AND SUMMARY OF THE INVENTION

The present invention relates to a drill bit with a spiral-tube-shaped drill shaft and a method for producing a spiral-tube-shaped drill shaft for such a drill bit.

Drill bits consist of a tube-shaped drill shaft, a cover that closes the tube-shaped drill shaft, and an insertion end above which the drill bit is fastened in the tool holder of a core drill. The cover and insertion end are parts of a receiving portion and the drill shaft is part of a drill shaft portion. The drill shaft portion and the receiving portion are detachably or permanently connected by means of a connecting device.

In the case of known drill bits, a distinction is made between fixed drill bits and drill bits that can be combined with separate cutting portions. Fixed drill bits have one or more cutting segments which are permanently connected to the drill shaft, whereby the cutting segments are welded, soldered, glued or fastened to the drill shaft in another suitable way. In the case of drill bits that are combined with separate cutting portions, the cutting portions can be connected to the drill bit via a detachable additional connecting device. The cutting portions comprise a ring portion and one or more cutting segments attached to the ring portion.

In drilling operation, a drill bit in a workpiece produces a drilled core with a core diameter and a borehole with a borehole diameter. The cutting segments form a cutting ring with an inner diameter corresponding to the core diameter and an outer diameter corresponding to the borehole diameter. When drilling, a distinction is made between wet drilling and dry drilling. Drill bits for wet drilling (wet drill bits) differ in design from drill bits for dry drilling (dry drill bits). Wet drilling requires a cooling and flushing fluid which cools the cutting segments of the drill bit or the cutting portion and removes the cuttings from the borehole as flushing fluid. Clean cooling and flushing fluid is usually supplied via an internal gap between the drilled core and the drill shaft and used cooling and flushing fluid mixed with cuttings is discharged via an external gap between the drill shaft and the borehole.

Drill bits, which have both an internal gap between drilled core and drill shaft and an external gap between drill shaft and borehole, are guided exclusively over the cutting segments during drilling, the entire drill shaft is not guided. The lack of guidance of the drill shaft can lead to undesired movements of the drill bit during drilling, which can impair the quality of the borehole. The stronger the movements of the drill bit, the stronger the geometry of the borehole can deviate from the circular form. In addition, elastic deformations of the drill shaft can occur due to the force exerted by the drilled core or the borehole on the drill shaft.

In order to improve the guidance of a drill bit, drill bits with no internal gap and/or no external gap are known, whereby the cooling and flushing fluid is transported via special transport channels in the outside of the drill shaft. The disadvantage is that the drill shaft has a large contact surface to the drilled core on the inside and a large contact surface to the borehole on the outside. The large contact surfaces on the inside and outside of the drill shaft lead to strong friction. The greater the friction between the drill shaft and the drilled core or the drill shaft and the borehole, the lower the drilling progress of the drill bit with the same performance of the core drill and the lower the service life of the drill shaft.

The object of this invention is to further develop a drill bit to improve the stability and guidance of the drill shaft during drilling, especially during wet drilling with a cooling and flushing fluid. In addition, the drilling progress of the drill bit is to be increased and/or the service life of the drill shaft extended.

According to the invention, the drill bit is characterized in that the tubular drill shaft is formed as a welded spiral tube, whereby a drill shaft formed as a welded spiral tube is also referred to as a spiral-tube-shaped drill shaft. A welded spiral tube has at least one spiral-shaped connection weld, which acts as a stiffening element for the drill shaft and increases the stiffness of the drill shaft compared to a long seam welded or tubular drill shaft of the same wall thickness. Alternatively, strip materials with lower wall thicknesses can be used, which have the same stiffness as a long seam welded or tubular drill shaft in the finished drill shaft. Thus, the use of a welded spiral tube as a drill shaft either increases the rigidity of the drill shaft during drilling and/or reduces the weight of the drill shaft. A drill shaft with a higher stiffness improves the stability of the drill shaft during drilling.

The inventive drill bit comprises a drill shaft portion with the spiral-tube-shaped drill shaft, a receiving portion with a cover and an insertion end and a connecting device, which connects the drill shaft portion and the receiving portion detachably or permanently. The connecting device is designed as a detachable or permanent connecting device. A connecting device is described as detachable, if the connection can be detached by the user without destruction, such as a plug connection, a pin connection or a threaded connection. A connection device is considered to be permanent, if the user can only detach the connection by destroying the connection means, such as a soldered connection, a welded connection or an adhesive connection. The drill bit is designed as a fixed drill bit and as a drill bit that can be combined with separate cutting portions. The fixed drill bit has one or more cutting segments which are permanently connected to the drill shaft, whereby the cutting segments are welded, soldered, glued or fastened to the drill shaft in another suitable way. In a drill bit combined with a separate cutting portion, the cutting portion is connected to the drill bit by a detachable connecting means, the cutting portion comprising a ring portion and one or more cutting segments attached to the ring portion.

The tubular drill shaft is preferably formed from N, N≥1 strip materials, whereby the strip edges of the strip materials are positively joined via N, N≥1 spiral-shaped connection welds. The drill shaft is made of one strip material (N=1) or several strip materials (N≥2), whereby the number of strip materials used corresponds to the number of spiral-shaped connection welds. During the production of the spiral-tube-shaped drill shafts, the strip materials are continuously formed into spiral tubes in a molding plant with a constant radius of curvature and welded to the strip edges in a welding line. In the production of spiral pipes, methods are known in joint forming and welding plants and methods in separate forming and welding plants.

In a first variant, the N, N≥1 strip materials are designed as flat sheets with a constant sheet thickness. The spiral-tube-shaped drill shaft is made of a flat sheet with a constant sheet thickness and a constant width. The flat sheets are formed into a spiral tube and joined together at the edges of the tape by means of spiral welding seams. The formed strip material has a constant wall thickness which corresponds to the sheet thickness of the flat sheets. The geometry of the spiral-shaped connection welds can be influenced by the process control during welding. By feeding a seam material, spiral-shaped connection welds can be produced, which protrude from the inside of the drill shaft, the outside of the drill shaft or the inside and outside of the drill shaft opposite the formed strip material.

In a second variant, the N, N≥1 strip materials are designed as flat sheets with at least one recess. The recesses are created in the sheet before the strip material is formed into a spiral tube and serve as a transport channel for the necessary cooling and flushing fluid during wet drilling. Wet drilling with a drill bit requires a cooling and flushing fluid which cools the cutting segments as the cooling fluid and removes cuttings from the borehole as the flushing fluid. The number of recesses, the geometry of the recesses and the arrangement of the recesses on the inside and/or outside of the drill shaft can be adapted to the amount of fluid in the cooling and flushing fluid. The recesses provided on the inside of the drill shaft are for the supply of clean cooling and flushing fluid and the recesses provided on the outside of the drill shaft are intended to discharge used cooling and flushing fluid mixed with cuttings. Since the recesses in the invention drill bit are made before the strip material is formed, recesses can be made on the inside of the drill shaft with little production effort. With known drill shafts, the arrangement of transport channels is limited to the outside of the drill shaft, since with a tubular drill shaft, recesses can only be made on the inside of the drill shaft with great production effort.

In a third variant, the N, N≥1 strip materials are designed as profiled sheets with a profiled cross section, whereby the profiled sheets have a sheet thickness and a profiled height. The spiral-tube-shaped drill shaft is made of plate-shaped profiled sheets. The course direction of the profiled cross-section is defined as the longitudinal direction of the plate-shaped profiled sheets. Plate-shaped profiled sheets are available in large quantities at low cost with different profiled cross-sections and enable cost-effective production of drill shafts for drill bits. The profiled cross-section creates recesses on the inside and outside of the drill shaft, through which the cooling and flushing fluid can be transported. The recesses provided on the inside of the drill shaft serve to supply clean cooling and flushing fluid and the recesses provided on the outside of the drill shaft serve to discharge used cooling and flushing fluid mixed with cuttings. The geometry of the profiled sheet can be adapted to the amount of fluid required for cooling and flushing.

In a preferred further development of the drill bit, at least one spiral-shaped connection weld of the drill shaft protrudes from the formed strip material of the spiral tube, with the at least one protruding spiral-shaped connection weld containing a seam material. A spiral-shaped connection weld protruding from the formed strip material of the spiral tube improves the guidance of the drill shaft during drilling. The protrusion of the spiral-shaped connection weld is adjusted, so that the spiral-shaped connection weld is in contact with the borehole on the outside of the drill shaft and/or with the drilled core on the inside of the drill shaft. Due to the protruding spiral-shaped connection weld, the drill shaft has a small contact surface to the drilled core and to the borehole and generates low friction. The lower the friction on the inside between the drill shaft and the drilled core or on the outside between the drill shaft and the borehole, the greater the drilling progress of the drill bit with the same performance of the drill bit and the increased service life of the drill shaft. The spiral-shaped connection weld can protrude from an inside of the drill shaft, from an outside of the drill shaft or from an inside and outside of the drill shaft opposite the formed strip material of the spiral tube. A seam material is required to produce a protrusion of the spiral-shaped connection weld. The seam material can be wire-shaped, tape-shaped or powder-shaped.

In addition to improved guidance of the drill shaft during wet and dry drilling, a spiral-shaped connection weld overlapping the formed strip material of the spiral tube can improve the transport of the cooling and flushing fluid during wet drilling. The protruding spiral-shaped connection weld acts as a conveying spiral for the cooling and flushing fluid. It should be noted that the protruding spiral-shaped connection weld can improve the fluid transport on the inside or outside of the drill shaft.

Clean cooling and flushing fluid are transported to the machining point on the inside of the drill shaft and used cooling and flushing fluid mixed with cuttings is transported away on the outside of the drill shaft. The spiral-shaped connection weld acts as a conveying spiral for the clean cooling and flushing fluid, if the direction of rotation of the drill bit and the direction of the spiral-shaped connection weld on the inside of the drill shaft coincide, and the spiral-shaped connection weld acts as a conveying spiral for the used cooling and flushing fluid mixed with cuttings, if the direction of rotation of the drill bit and the direction of the spiral-shaped connection weld on the outside of the drill shaft coincide.

In a preferred variant, the seam material and the N, N≥1 strip materials have the same material properties. If the seam material and the strip materials have the same material properties, a uniform transition occurs when the tape edges are welded, and the seam material can bond well with the strip material.

In an alternative preferred variant, the seam material and the N, N≥1 strip materials have different material properties, with the seam material having higher tensile strength, higher wear resistance or higher tensile strength and wear resistance than the strip materials. In the case of a spiral-shaped connection weld that protrudes from the formed strip material, the connection weld is to allow the drill shaft to be guided during drilling operation. The smaller the gap between the spiral-shaped connection weld and the drilled core on the inside of the drill shaft or between the spiral-shaped connection weld and the borehole on the outside, the better the drill shaft is guided. Friction between the spiral-shaped connection weld and the drilled core on the inside or between the spiral-shaped connection weld and the borehole on the outside can cause the spiral-shaped connection weld to be removed, which impairs the guidance of the drill shaft. By using seam material having a higher tensile strength, a higher wear resistance or a higher tensile strength and wear resistance than the strip materials, the properties of the spiral-shaped connection weld can be influenced, so that the guidance of the drill shaft via the spiral-shaped connection weld is ensured as far as possible during the entire service life of the drill shaft.

In a first preferred variant, at least one protruding spiral-shaped connection weld on an inside of the drill shaft protrudes with an inner protrusion Δ_{I} over the formed strip material of the spiral tube. A spiral-shaped connection seam protruding from the inside of the drill shaft makes it possible to guide the drill shaft over the drilled core when drilling with the drill bit. The inner protrusion of the spiral-shaped connection weld is set so that the spiral-shaped connection weld is in contact with the drill bit on the inside of the drill shaft after the drill bit has been drilled. In addition, a spiral-shaped connection weld protruding from the inside of the drill shaft can support the transport of the clean cooling and flushing fluid to the machining point during wet drilling with the drill bit. The spiral-shaped connection weld acts as a conveying spiral for the clean cooling and flushing fluid when the direction of rotation of the drill bit and the direction of the spiral-shaped weld connection on the inside of the drill shaft coincide.

In a second preferred variant, at least one protruding spiral-shaped connection weld protrudes on an outside of the drill shaft with an outer protrusion Δ_{A} from the formed strip material of the spiral tube. A spiral-shaped connection weld protruding from the outside of the drill shaft allows the drill shaft to be guided over the borehole when drilling with a drill bit. The outer protrusion of the spiral-shaped connection weld is adjusted so that the spiral-shaped connection weld is in contact with the borehole after the drill bit has been drilled on the outside of the drill shaft. In addition, a spiral-shaped connection weld protruding from the outside of the drill shaft can support the removal of the used cooling and flushing fluid mixed with cuttings during wet drilling with the drill bit. The spiral-shaped connection weld acts as a conveyance spiral for the used cooling and flushing fluid mixed with the cuttings when the direction of rotation of the drill bit and the direction of the spiral-shaped connection weld on the outside of the drill shaft coincide.

In a third preferred variant, at least one spiral-shaped connection weld is located on an inside of the drill shaft with an inner protrusion Δ_{I} and on an outside of the drill shaft with an outer protrusion Δ_{A} from the formed strip material of the spiral tube. A spiral-shaped connecting weld protruding from the inside and outside of the drill shaft allows the drill shaft to be guided over the drilled core both on the inside of the drill shaft and over the borehole on the outside of the drill shaft when drilling with the drill bit. The spiral-shaped connection weld protruding from the inside and outside of the drill shaft acts as a conveying spiral for the cooling and flushing fluid during wet drilling on the inside or outside of the drill shaft. The direction of the spiral-shaped connection weld determines whether the spiral-shaped connection weld supports the fluid transport on the inside or outside of the drill shaft. When the direction of the spiral-shaped connection weld and the direction of rotation of the drill bit on the inside of the drill shaft coincide, the spiral-shaped connection weld supports the fluid transport on the inside of the drill shaft. When the direction of the spiral-shaped connection weld and the direction of rotation of the drill bit on the outside of the drill shaft coincide, the spiral-shaped connection weld supports the fluid transport on the outside of the drill shaft.

According to the invention, the method of producing a drill shaft for a drill bit according to one of the claims 1 to 12 is characterized in that the N, N≥1 strip materials are formed into a spiral tube and spiral-shaped connecting welds are positively connected at the strip edges via N, N≥1. The method according to the invention allows a cost-effective production of a spiral-tube-shaped drill shaft for a drill bit. The strip materials are continuously formed into spiral tubes in a spiral-forming line with a constant radius of curvature and welded at the strip edges in a welding line.

In a preferred further development of the method, a seam material is used when joining the abutting strip edges of the N, N≥1 strip materials over the N, N≥1 spiral-shaped connection welds. The seam material is, for example, wire-shaped, tape-shaped or powder-shaped and produces a spiral-shaped connection weld that protrudes from the formed strip material. The use of seam material when positively joining the edges of the abutting band together can form spiral-shaped connection welds which protrude beyond the formed strip material. The protruding spiral-shaped connection welds guide the drill shaft over the drilled core and/or over the borehole on the outside of the drill shaft when drilling on the inside of the drill shaft. The geometry of the spiral-shaped connection weld can be influenced by the process control during welding. The seam material can be fed to the inside of the drill shaft, the outside of the drill shaft or the inside and outside of the drill shaft.

In a particularly preferred variant of the method, the seam material has a higher tensile strength, a higher wear resistance or a higher tensile strength and wear resistance than the N, N≥1 strip materials. The use of seam materials having a higher tensile strength, higher wear resistance or higher tensile strength and wear resistance than the strip materials can influence the properties of the spiral-shaped connection weld, so that the guidance of the drill shaft over the spiral-shaped connection weld is ensured as far as possible throughout the life of the drill shaft.

In an alternative particularly preferred variant of the method, a first seam material and a second seam material are used when joining the abutting strip edges of the N, N≥1 strip materials via the spiral-shaped connection welds, the material properties of the first seam material being different from the material properties of the second seam material. The material properties of the seam used can be used to influence the properties of the spiral-shaped connection welds. For example, the first seam material can have the same material properties as the strip materials, so that a uniform transition between the strip edges occurs during welding and the first seam material can bond well with the strip material. For example, the second seam material may have a higher tensile strength, higher wear resistance, or higher tensile strength and wear resistance than the strip materials and may improve the properties of the spiral-shaped connection welds.

Exemplary embodiments of the invention are described in the following drawings. The drawings are not necessarily intended to represent the exemplary embodiments to scale, but rather the drawings, where useful for explanation, are shown in schematic and/or slightly distorted form. It should be noted that many modifications and changes can be made to the form and detail of the exemplary embodiments without deviating from the general idea of the invention. The general idea of the invention is not limited to the exact form or detail of the preferred exemplary embodiments shown and described below or limited to an object which is limited in comparison to the object claimed in the claims. For given dimensioning ranges, values lying within the limits mentioned should also be disclosed as limit values and be arbitrarily usable and claimable. For the sake of simplicity, the same reference signs are used below for identical or similar parts or parts with identical or similar functions.

### BRIEF DESCRIPTION OF THE DRAWINGS

FIGS. 1A, B show a first embodiment of an inventive drill bit with a spiral-shaped shaft, the drill bit being connectable to a separate cutting portion;

FIGS. 2A, B show a longitudinal section through the drill bit of FIG. 1 along the cutting line A-A in FIG. 1B (FIG. 2A) and a detail of the drill shaft of FIG. 2A in an enlarged view (FIG. 2B);

FIG. 3 shows a second embodiment of an inventive drill bit with a spiral-tube-shaped drill shaft, which is connected to several cutting segments and has three recesses on the inside;

FIGS. 4A, B show a longitudinal section through the drill bit of FIG. 3 along the cutting line A-A in FIG. 3 (FIG. 4A) as well as a detail of the drill shaft of FIG. 4A in an enlarged representation (FIG. 4B);

FIG. 5 shows a third embodiment of an inventive drill bit with a spiral-tube-shaped drill shaft connected to several cutting segments and made of a profiled sheet; and

FIGS. 6A, B show a longitudinal section through the drill bit of FIG. 5 along the cutting line A-A in FIG. 5 (FIG. 6A) as well as a detail of the drill shaft of FIG. 6A in an enlarged representation (FIG. 6B).

### DETAILED DESCRIPTION OF THE DRAWINGS

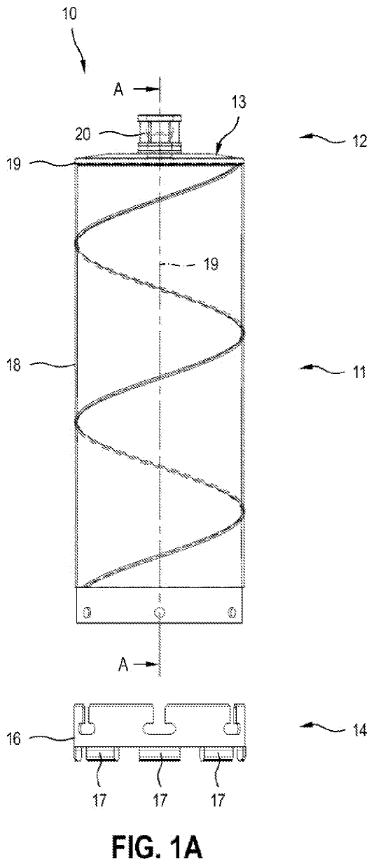

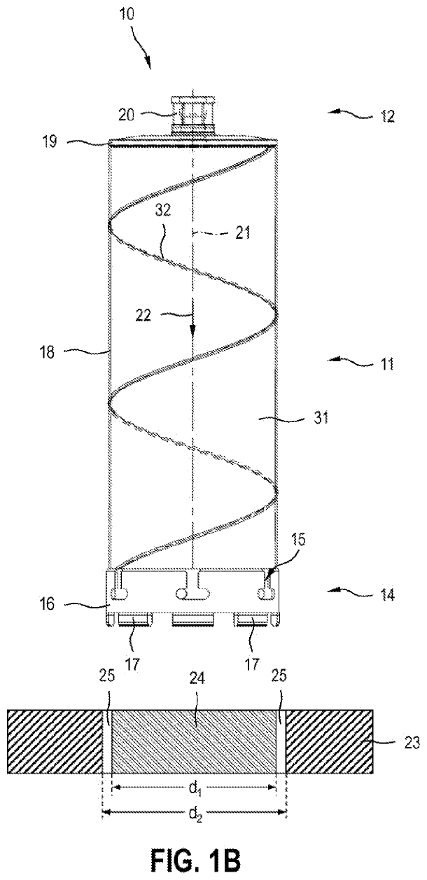

FIGS. 1A, B show a first embodiment of an inventive drill bit 10, hereinafter referred to as the first drill bit 10. The first drill bit 10 comprises a drill shaft portion 11, a receiving portion 12 and a connecting device 13 which permanently connects the drill shaft portion 11 to the receiving portion 12. The first drill bit 10 can be connected to a separate cutting portion 14 via another detachable connecting device 15. FIG. 1A shows the first drill bit 10 and the cutting portion 14 in the unconnected state and FIG. 1B the first drill bit 10 and the cutting portion 14 in the connected state.

The cutting portion 11 comprises a ring portion 16 and several cutting segments 17 connected to the ring portion 16. The cutting segments 17 are arranged in a ring shape and form a cutting ring with intermediate spaces. The cutting portion 14 can also have a single cutting segment designed as a closed cutting ring instead of several cutting segments 17. The cutting segments 17 are welded, soldered, glued or fastened in another suitable way to the ring portion 16. The drill shaft portion 11 comprises a spiral-tube-shaped drill shaft 18 and the receiving portion 12 comprises a cover 19 and an insertion end 20 over which the first drill bit 10 is fastened in a tool holder of a core drill. In drilling operation, the first drill bit 10 is driven by the core drill about a drilling axis 21 and moved in a drilling direction 22 parallel to the drilling axis 21 into a workpiece 23 to be machined. The first drill bit 10 produces a drilled core 24 with a core diameter d₁ and a borehole 25 with a borehole diameter d₂ in the workpiece 23.

The drill shaft 18 is designed as a welded spiral tube, which was manufactured from a strip material 31 in the form of a flat sheet by forming and welding. The flat strip material 31 was formed into a spiral tube and joined at the abutting strip edges by means of a spiral-shaped connection weld 32. The spiral-shaped connection weld 32 acts as a stiffening element for the drill shaft 18 and increases the stiffness of the drill shaft 18 compared to a longitudinally welded or tubular drill shaft of the same wall thickness.

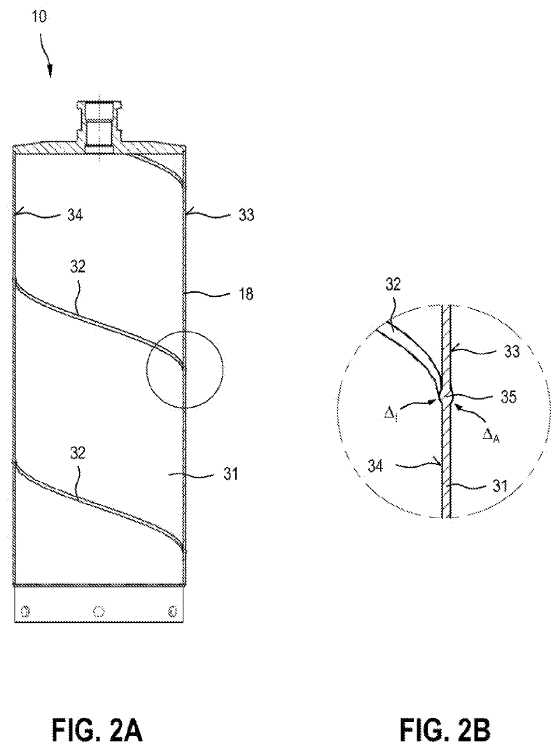

FIGS. 2A, B show a longitudinal section through the first drill bit 10 of FIG. 1 along the cutting line A-A in FIG. 1B (FIG. 2A) and a detail of the drill shaft 16 of FIG. 2A in a magnified view (FIG. 2B).

The spiral-shaped connection weld 32 protrudes from the formed strip material 31 on an outside 33 and an inside 34 of the drill shaft 16. The protrusion of the spiral-shaped connection weld 32 on the outside 33 of the drill shaft 16 is called the outer protrusion Δ_{A} and the protrusion of the spiral-shaped connection weld 32 on the inside 34 of the drill shaft 16 is called the inner protrusion Δ_{I}. In order to produce the spiral-shaped connection weld 32 protruding from the formed strip material 31 on the outside and inside 33, 34, a seam material 35 is used for welding the formed strip material 31, which provides the required material volume. The seam material 35 can be powder-shaped, wire-shaped or tape-shaped. Furthermore, the material properties of the seam material 35 can be adapted to the desired properties of the spiral-shaped connection weld 32.

The spiral-shaped connection weld 32 improves the guidance of the drill shaft 18 when drilling with the first drill bit 10. The smaller the gap between the spiral-shaped connection weld 32 and the borehole 25 on the outside 33 or between the spiral-shaped connection weld 32 and the drilled core 23 on the inside 34, the better the guidance of the drill shaft 18. The spiral-shaped connection weld 32 can be removed through friction between the spiral-shaped connection weld 32 and the borehole 25 on the outside 33 or between the spiral-shaped connection weld 32 and the drilled core 24 on the inside 34, whereby the guidance of the drill shaft 18 deteriorates. By using seam material 35, which has a higher tensile strength and wear resistance than the strip material 31, the properties of the spiral-shaped connection weld 32 can be influenced, so that guidance of the drill shaft 18 over the spiral-shaped connection weld 32 is ensured as far as possible during the entire service life of the drill shaft 18.

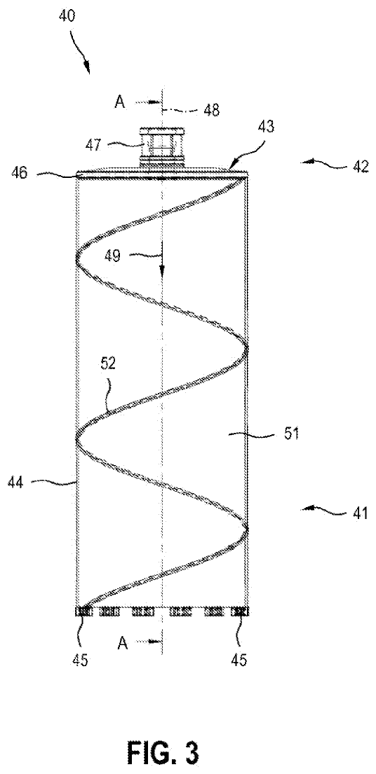

FIG. 3 shows a second embodiment of an inventive drill bit 40, hereinafter referred to as the second drill bit 40. The second drill bit 40 comprises a drill shaft portion 41, a receiving portion 42, and a connecting device 43, which permanently connects the drill shaft portion 41 to the receiving portion 42.

Drill shaft portion 41 includes a spiral-tube-shaped drill shaft 44 and multiple cutting segments 45 that are welded, soldered, bonded or fastened to the drill shaft 44 in any other suitable manner. The receiving portion 42 comprises a cover 46 and an insertion end 47, through which the third drill bit 40 is fastened in a tool holder of a core drill. In drilling operation, the second bit 40 is driven by the core drill about a drilling axis 48 and moved in a drilling direction 49 parallel to the drilling axis 48 into the workpiece 23 to be machined.

The second drill bit 40 has several cutting segments 45, which are permanently attached to the drill shaft 44. The second drill bit 40 can also have a single cutting segment designed as a closed cutting ring instead of several cutting segments 45. The cutting segments 45 are welded, soldered, glued or fastened in another suitable way to the drill shaft 44.

The drill shaft 44 is designed as a spiral tube in the form of a welded spiral tube, which was manufactured from a strip material 51 in the form of a flat sheet with recesses by forming and welding. The strip material 51 was formed into a spiral tube and joined at the abutting strip edges by means of a spiral-shaped connection weld 52.

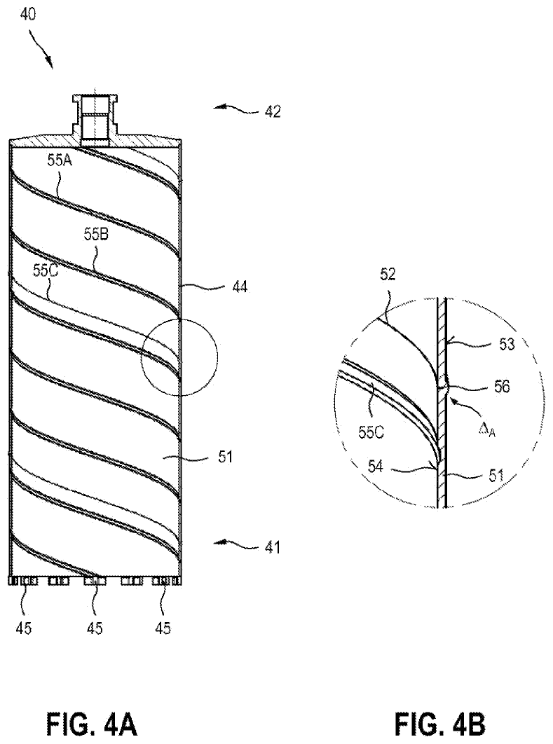

FIGS. 4A, B show a long section through the second drill bit 40 of FIG. 3 along the intersection line A-A in FIG. 3 (FIG. 4A) and a detail of the drill shaft 46 of FIG. 4A in an enlarged representation (FIG. 4B).

The spiral-shaped connection weld 52 of the drill shaft 44 protrudes from an outside 53 of the drill shaft 44 with an outer protrusion Δ_{A} in relation to the formed strip material 51 and is substantially flush with the formed strip material 51 on an inside 54 of the drill shaft 44. In order to produce the spiral-shaped weld 52 protruding from the outside 53, a seam 55 is used when welding the formed strip material 51, which provides the required material volume.

The seam material 55 can be shaped as powder, wire or tape. The properties of the spiral-shaped connection weld 52 can be adapted via the material properties of the seam material 55. The seam material 55 can have the same material properties or different material properties as the strip material 51. If the seam material 55 and the strip material 51 have the same material properties, the weld of the tape edges results in a uniform transition and the seam material 55 can bond well with the strip material 51. By using a seam material 55, which has a higher tensile strength and/or wear resistance than the strip material 51, the properties of the spiral-shaped connection weld 52 can be influenced, so that guidance of the drill shaft 44 over the spiral-shaped connection weld 52 is ensured as far as possible during the entire service life of the drill shaft 46.

The second drill bit 40 shows a spiral-tube-shaped drill shaft 44 with a spiral-shaped connection weld 52, which protrudes on the outside 53 of the drill shaft 44 from the formed strip material 51 and is formed substantially flush with the formed strip material 51 on the inside 54 of the drill shaft 44. Alternatively, the spiral-shaped connection weld 52 on the inside 54 of the drill shaft 44 can protrude with an inner protrusion Δ_{I} in relation to the formed strip material 51 and be substantially flush with the formed strip material 51 on the outside 53 of the drill shaft 46. A spiral-shaped connection weld 52 protruding from the inside 54 of the drill shaft 44 allows the drill shaft 44 to be guided over the drilled core 24 when drilling with the second drill bit 40. In addition, the spiral-shaped connection weld 52 protruding from the inside 54 can support the supply of clean cooling and flushing fluid during wet drilling. The spiral-shaped connection weld 52 acts as a conveying spiral for the clean cooling and flushing fluid when the direction of rotation of the second drill bit 40 and the direction of the spiral-shaped connection weld 52 on the inside 54 of the drill shaft 44 coincide.

Wet drilling with the second drill bit 40 requires a cooling and flushing fluid, which cools the cutting segments 45 as cooling fluid and removes cuttings from the borehole 25 as flushing fluid. The spiral-shaped connection weld 52 protruding from the outside 53 of the drill shaft 44 can support the removal of used cooling and flushing fluid mixed with cuttings, in addition to guiding the drill shaft 44 through the borehole 25. The spiral-shaped connection weld 52 acts as a conveying spiral for the used cooling and flushing fluid mixed with cuttings, when the direction of rotation of the second drill bit 40 and the direction of the spiral-shaped connection weld 52 on the outside 53 of the drill shaft 44 coincide.

Three recesses 56A, 56B, 56C, known as the first recess 56A, the second recess 56B and the third recess 56C, are located on the inside 54 of the drill shaft 44 to provide clean cooling and flushing fluid to the inside 54 of the drill shaft 44. The recesses 56A, 56B, 56C are created in the sheet prior to forming the strip material 51 into a spiral tube and serve as a transport channel for the necessary cooling and flushing fluid when wet drilling with the second bit 40. The recesses 56A, 56B, 56C are necessary especially in case of a small internal gap between the drilled core and the drill shaft. The number of recesses 56A, 56B, 56C, the geometry of the recesses 56A, 56B, 56C and the arrangement of the recesses 56A, 56B, 56C on the outside 53 and/or inside 54 of the drill shaft 44 can be adapted to the amount of fluid in the cooling and flushing fluid.

The recesses 56A, 56B, 56C provided on the inside 54 of the drill shaft 44 are for the supply of clean cooling and flushing fluid and the recesses provided on the outside 53 of the drill shaft 44 can support the removal of used cooling and flushing fluid mixed with cuttings. Since the recesses 56A, 56B, 56C are made on the second drill bit 40 before the strip material 51 is formed, recesses can be created on the inside 54 of the drill shaft 44 with little manufacturing effort.

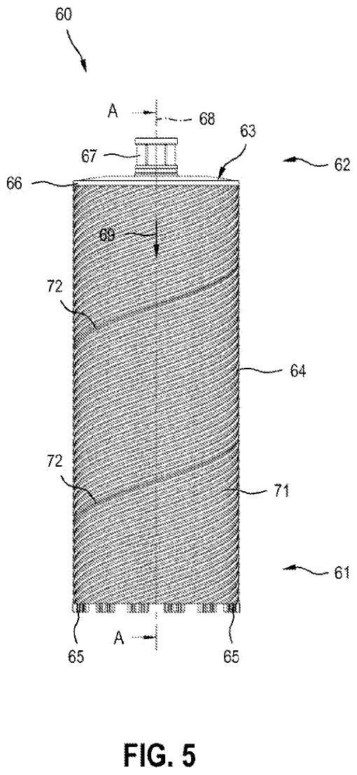

FIG. 5 shows a third embodiment of an inventive drill bit 60, hereinafter referred to as the third drill bit 60. The third drill bit 60 comprises a drill shaft portion 61, a receiving portion 62 and a connecting device 63, which connects the drill shaft portion 61 permanently with the receiving portion 62.

Drill shaft portion 61 includes a spiral-tube-shaped drill shaft 64 and multiple cutting segments 65 welded, soldered, bonded or otherwise fastened to the drill shaft 64 in another suitable manner. The receiving portion 62 includes a cover 66 and an insertion end 67, over which the third drill bit 60 is fastened in a tool holder of a core drill. In drilling operation, the third drill bit 60 is driven by the core drill about a drilling axis 68 and moved in a drilling direction 69 parallel to the drilling axis 68 into the workpiece 23 to be machined.

The third drill bit 60 has several cutting segments 65, which are attached to the drill shaft 64 in a permanent manner. The third drill bit 60 can also have a single cutting segment designed as a closed cutting ring instead of several cutting segments 65. The cutting segments 65 are welded, soldered, glued or fastened in another suitable way to the drill shaft 64.

The drill shaft 64 is designed as a welded spiral tube, which was manufactured from a strip material 71 in the form of a wave-shaped profiled sheet by forming and welding. The strip material 71 was formed into a spiral tube and joined at the abutting strip edges by means of a spiral-shaped connection weld 72. The spiral-shaped connection weld 72 acts as a stiffening element for the drill shaft 64.

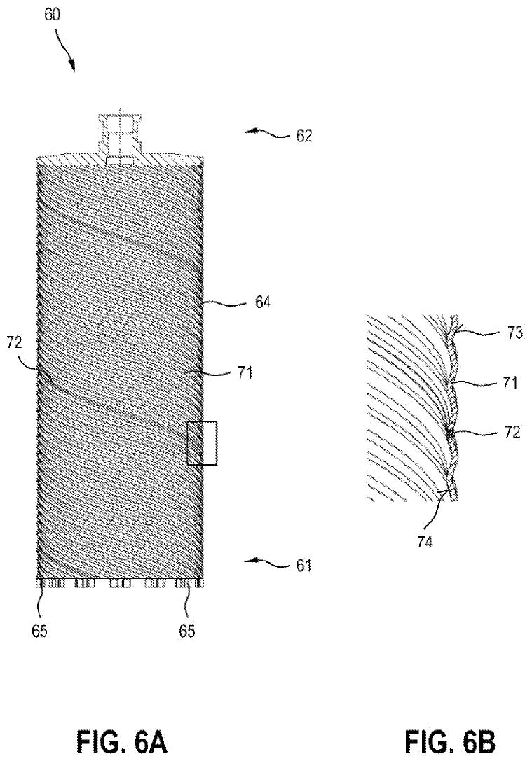

FIGS. 6A, B show a longitudinal section through the third drill bit 60 of FIG. 5 along the cutting line A-A in FIG. 5 (FIG. 6A) as well as a detail of the drill shaft 64 of FIG. 6A in an enlarged representation (FIG. 6B).

The spiral-shaped connection weld 72 of the drill shaft 64 is formed on an outside 73 of the drill shaft 64 and on an inside 74 of the drill shaft 64 substantially flush with the formed strip material 71. Due to the profiled cross-section of the strip material 71, 66 recesses are created on the outside 73 and on the inside 74 of the drill shaft, through which cooling and flushing fluid can be transported during wet drilling with the third drill bit 60. The recesses provided on the inside 74 of the drill shaft 64 are for the supply of clean cooling and flushing fluid and the recesses provided on the outside 73 of the drill shaft 64 are for the discharge of used cooling and flushing fluid mixed with cuttings. The geometry of the profiled sheet can be adapted to the amount of fluid required for wet drilling.

1.-16. (canceled)

17. A drill bit for creating a borehole having a borehole diameter and having a drilled core having a core diameter in a workpiece, comprising:
a drill shaft portion with a tubular drill shaft;
a receiving portion which has a cover and an insertion end; and
a connecting device which connects the drill shaft portion and the receiving portion together releasably or non-releasably;
wherein the tubular drill shaft is configured as a welded spiral tube.

18. The drill bit according to claim 17, wherein the tubular drill shaft is formed from N, wherein N>1, strip materials and wherein respective strip edges of the strip materials are integrally joined by N, wherein N>1, spiral-shaped connection welds.

19. The drill bit according to claim 18, wherein the strip materials are configured as flat sheets having a constant sheet thickness.

20. The drill bit according to claim 18, wherein the strip materials are configured as flat sheets having at least one recess.

21. The drill bit according to claim 18, wherein the strip materials are configured as profiled sheets with a profiled cross-section and wherein the profiled sheets have a sheet thickness and a profiled height.

22. The drill bit according to claim 18, wherein at least one of the spiral-shaped connection welds protrudes relative to the strip materials and wherein the at least one of the spiral-shaped connection welds contains a seam material.

23. The drill bit according to claim 22, wherein the seam material and the strip materials have same material properties.

24. The drill bit according to claim 22, wherein the seam material and the strip materials have different material properties.

25. The drill bit according to claim 24, wherein the seam material has a higher tensile strength and/or a higher wear resistance than the strip materials.

26. The drill bit according to claim 22, wherein the at least one of the spiral-shaped connection welds protrudes on an inside of the tubular drill shaft with an inner protrusion relative to the strip materials.

27. The drill bit according to claim 22, wherein the at least one of the spiral-shaped connection welds protrudes on an outside of the tubular drill shaft with an outer protrusion relative to the strip materials.

28. The drill bit according to claim 22, wherein the at least one of the spiral-shaped connection welds protrudes on an inside of the tubular drill shaft with an inner protrusion relative to the strip materials and on an outside of the tubular drill shaft with an outer protrusion relative to the strip materials.

29. A method for producing the tubular drill shaft for the drill bit according to claim 17, wherein N, wherein N≥1, strip materials are shaped into a spiral tube and are integrally joined at respective abutting strip edges by N, wherein N≥1, spiral-shaped connection welds.

30. The method according to claim 29, wherein a seam material is used when integrally joining the respective abutting strip edges.

31. The method according to claim 30, wherein the seam material has a higher tensile strength and/or a higher wear resistance than the strip materials.

32. The method according to claim 29, wherein when integrally joining the respective abutting strip edges a first seam material and a second seam material are used, wherein material properties of the first seam material are different from material properties of the second seam material.
